(19) United States
(12) Patent Application Publication
(10) Pub. No.: US 2023/0177383 A1
(43) Pub. Date: Jun. 8, 2023

(54) ADJUSTING MACHINE LEARNING MODELS BASED ON SIMULATED FAIRNESS IMPACT

(71) Applicant: International Business Machines Corporation, Armonk, NY (US)

(72) Inventors: Pranay Kumar Lohia, Bhagalpur (IN); Kushal Mukherjee, New Delhi (IN); Rakesh Rameshrao Pimplikar, Bangalore (IN); Monika Gupta, GURUGRAM (IN); Sameep Mehta, Bangalore (IN); Stacy F. Hobson, Hopewell Junction, NY (US)

(21) Appl. No.: 17/544,077

(22) Filed: Dec. 7, 2021

(51) Int. Cl. G06N 20/00

(52) U.S. Cl. CPC G06N 20/00

(57) ABSTRACT

Methods, systems, and computer program products for adjusting machine learning models based on simulated fairness impact are provided herein. A computer-implemented method includes obtaining, by a central simulation system, policies to be used for performing a simulation involving machine learning models, implemented on different systems, interacting with a target population; providing information for configuring simulators on the different systems, each simulator representing at least the machine learning model of a given one of the different systems; performing iterations of the simulation for the policies, wherein, for each iteration, the central simulation system: predicts a state of the target population, provides the state to the simulators, and collects metrics based on results of the simulators; and selecting and sending one of the policies to at least one of the different systems based on the collected metrics.

### BACKGROUND

The present application generally relates to information technology and, more particularly, to machine learning (ML).

Generally, ML models can be trained to find associations between entities and attributes for a given task. ML models are generally susceptible to different types of bias when trained on a large text corpus, which can impact the fairness of the ML, model.

### SUMMARY

In one embodiment of the present disclosure, techniques for adjusting machine learning models based on simulated fairness impact are provided. An exemplary computer-implemented method includes obtaining, by a central simulation system, a plurality of policies to be used for performing a simulation involving multiple machine learning models interacting with a target population, wherein the machine learning models are implemented on different systems; providing information for configuring simulators on the different systems, each simulator representing at least the machine learning model of a given one of the different systems; performing multiple iterations of the simulation for the plurality of policies, wherein, for each iteration, the central simulation system: (i) predicts a state of the target population, (ii) provides the state of the target population to the simulators, and (iii) collects one or more metrics based on results of the simulators; and selecting and sending one of the policies to at least one of the different systems based on the collected metrics, wherein the at least one system updates its corresponding machine learning model based at least in part on the selected policy.

Another embodiment of the present disclosure or elements thereof can be implemented in the form of a computer program product tangibly embodying computer readable instructions which, when implemented, cause a computer to carry out a plurality of method steps, as described herein. Furthermore, another embodiment of the present disclosure or elements thereof can be implemented in the form of a system including a memory and at least one processor that is coupled to the memory and configured to perform noted method steps. Yet further, another embodiment of the present disclosure or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present disclosure will become apparent from the following detailed description of illustrative embodiments thereof, which is to be read in connection with the accompanying drawings.

### BRIEF DESCRIPTION OF THE DRAWINGS

FIG. 1 is a high-level system diagram illustrating multiple machine learning models interacting with an environment in accordance with exemplary embodiments;

FIG. 2 is a system architecture for determining impact of policies on the fairness of machine learning models in accordance with exemplary embodiments;

FIG. 3 is process flow diagram for simulating impact of policies on fairness of machine learning models in accordance with exemplary embodiments;

FIG. 4 is a flow diagram illustrating techniques for adjusting machine learning models in accordance with exemplary embodiments;

FIG. 5 is a system diagram of an exemplary computer system on which at least one embodiment of the present disclosure can be implemented;

FIG. 6 depicts a cloud computing environment in accordance with exemplary embodiments; and

FIG. 7 depicts abstraction model layers in accordance with exemplary embodiments.

### DETAILED DESCRIPTION

A ML model generally is trained on a set of training data that is susceptible to different types of biases (e.g., contextual bias and/or associative bias), which can affect the fairness of the ML model. Some software tools exist to aid developers in creating an unbiased ML model, and also to make the ML model more robust in view of perturbations in population distributions, such as static analysis techniques. Generally, these tools fail to consider the long-term fairness of the ML model. For example, after the ML model is deployed, its output can directly and/or indirectly change population distributions or impact new data that the ML model processes. Also, multiple AI models (e.g., from different developers or enterprises) can be interacting and affecting the same population, and each of the ML models with varying degrees of fairness. Existing tools do not identify long-term impacts on the fairness of a given AI model in such circumstances.

As described herein, an exemplary embodiment includes providing a framework that enables a user to predict the long-term impact of particular policies and/or processes on fairness metrics of an ML model for a target population that is interacting with the ML model as well as one or more other ML models (e.g., from different developers or enterprises). Some embodiments allow users to expose respective processes (e.g., associated with the ML models) as a black box via the framework. Details of the process can be kept private and not revealed to other users or systems. In some embodiments, a determined set of policy controls is applied across different processes during a simulation, and a population simulator is configured to obtain a future state of the population based on the actions of the ML models and the policy controls. Accordingly, a closed-loop simulation involving multiple ML models interacting with the simulated population can be performed. Also, a software governance process can be used to periodically validate if performance and/or fairness metrics calculated from the simulation for the ML models reflect what is actually occurring in the real world. The simulation framework can adjust the predicted metrics when a new process (e.g., an ML model in the same domain) is introduced, without having to rerun the simulation. The adjustment can be based on historical data associated with the new process, for example.

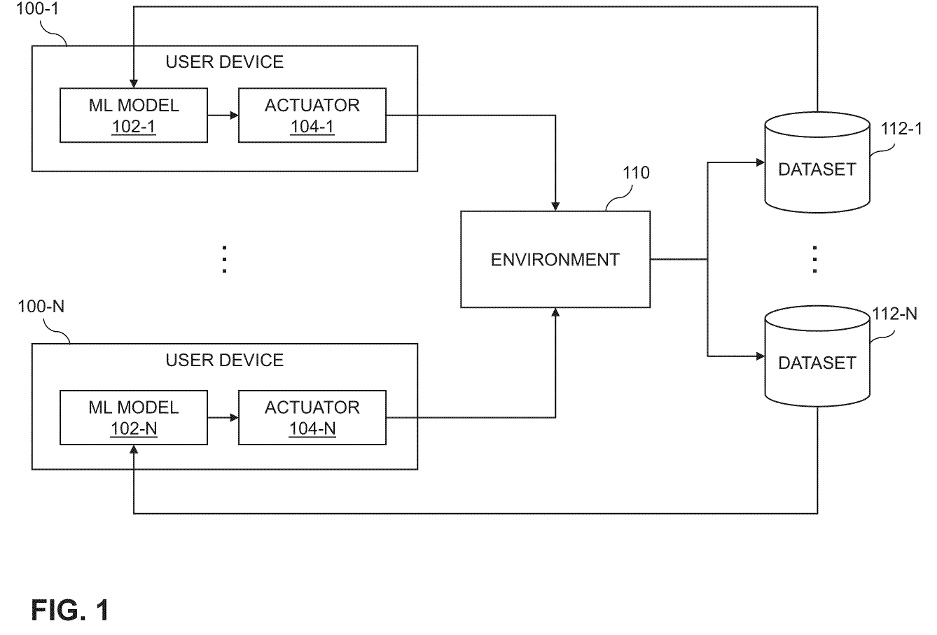

FIG. 1 is a diagram illustrating a system architecture in accordance with exemplary embodiments. By way of illustration, FIG. 1 depicts one or more user devices 100-1, ..., 100-N (collectively referred to as user devices 100) interacting with an environment 110. The user devices 100 include respective ML models 102-1, ..., 102-N (collectively ML models 102), and respective actuator 104-1, ..., 104-N (collectively actuators 104). Generally, each of the ML models 102 are trained on respective datasets 112-1, ..., 112-N (collectively datasets 112) to perform a machine learning task, and the actuators 104 are configured to interact with the environment 110 based on the outputs of the ML models 102. For example, the actuators 104 can perform one or more automated actions. The datasets 112 are continuously updated and fed back to the ML models 102 as interactions with the environment 110 occur (possibly including actions of other agents or systems). The interactions with the environment 110 may eventually impact the fairness of one or more of the ML models 102 that initially satisfied a set of fairness metrics.

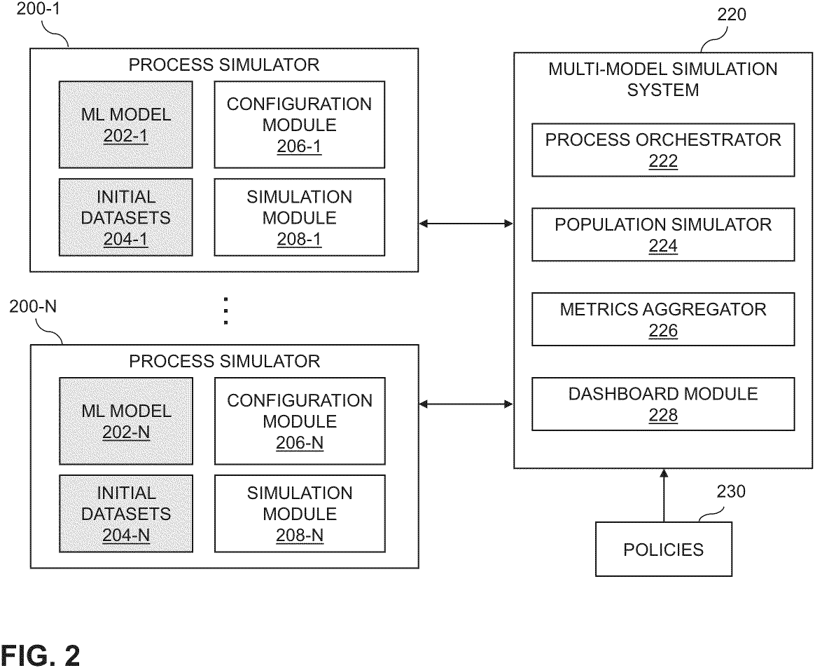

FIG. 2 is a system diagram for determining impact of policies on the fairness of machine learning models in accordance with exemplary embodiments. The FIG. 2 example depicts a plurality of process simulators 200-1, ..., 200-N (collectively referred to herein as process simulators 200) and a multi-model simulation system 220. In the FIG. 2 embodiments, each of the process simulators 200 is assumed to comprise respective ML models 202-1, ..., 202-N (collectively ML models 202), respective initial datasets 204-1, ..., 204-N (collectively initial datasets 204), respective configuration modules 206-1, ..., 206-N (collectively configuration modules 206), and respective simulation modules 208-1, ..., 208-N (collectively simulation modules 208). In some embodiments, each of the process simulators 200 correspond to different enterprises (or users) and can execute at least in part in private clouds of the corresponding enterprise.

The initial datasets 204 may include data relating to processes of the enterprise or user associated with corresponding process simulators 200, including data used to initial train the ML, models 202. Accordingly, the initial datasets 204 and the details of the ML models 202 can comprise private or confidential information (as indicated by the darker shading in FIG. 2) that should not be shared with other process simulators 200 or the multi-model simulation system 220.

The configuration modules 206 generally provide a simple interface that allows users of the process simulators to describe process flow, including the process flow of the ML models 202. For example, the process flow can be provided using a BPMN notation, so that the current logic and/or algorithm of the ML model 202-1 can be used for specific automation tasks. Additional information related to one or more of the process simulators 200 can also be provided (e.g., meta-information and/or personas). For example, meta-information may include dataset details such as datatype and data distribution and/or model details such as model type, hyper-parameters, model policy, and thresholds. Such information can be used as an input to perform finetuning.

The representation of the process flow resulting from the configuration modules 206 can be exposed to process orchestrator 222 via one or more application programming interfaces (APIs) as a black box (e.g., without disclosing the underlying details). The configuration modules 206 also provide functionality for receiving policies 230 from the multi-model simulation system, which can be incorporated into their respective ML models 202 (or possibly other associated processes and/or tasks).

The simulation modules 208 generate actions (e.g., corresponding to the ML models) to be used in the simulation based at least in part on the policies 230 and population data provided by the multi-model simulation system 220. The simulation modules 208, in some embodiments, also provide a set of fairness and/or performance metrics (e.g., key performance indicators (KPIs) to the multi-model simulation system 220, as described in more detail elsewhere herein.

The multi-model simulation system 220 includes a process orchestrator 222, a population simulator 224, a metrics aggregator 226, and a dashboard module 228. In this example, the multi-model simulation system 220 obtains one or more policies 230 to be used in a simulation using the process simulators 200, as described in more detail elsewhere herein.

Generally, the process orchestrator 222 provides information for configuring and interacting with the process simulators 200 during the simulation. For example, the information may include one or more APIs, and at least a portion of the policies 230 for allowing the multi-model simulation system 220 to interact with the configuration modules 206 and the simulation modules 208 of the process simulators 200. The process orchestrator 222 obtains a current state of the population from the population simulator 224 and provides it to the process simulators 200.

The population simulator 224 models state transitions of individuals of a target population based on actions of the process simulators 200 and, possibly, behavior derived from demographic data. For example, the population simulator 224 can obtain output from simulation modules 208 during each iteration of the simulation, and update a state of a target population based on the output. As an example, state transitions can be denoted as: state of individual (T+1) = F (State of individual (T), Action performed on individual by enterprises (T)), where F corresponds to the model of population simulator 224. The population simulator 224, in some embodiments, is developed based at least in part on a toolkit for developing and comparing ML, algorithms, such as OpenAI Gym.

The metrics aggregator 226 collects and aggregates the metrics provided by the simulation modules 208 and estimates the impact of the policies 230. The dashboard module 228 can provide results of the simulation and/or the aggregated metrics to a user (via a user interface) or another system, for example. For example, the dashboard module 228 can rank the different policies 230 and output a particular one of the policies 230 based on the ranking.

The policies 230 generally can be considered as guardrails that have an impact on users or enterprises associated with the process simulators 200, for example. For example, guardrails can include descriptive information, including fairness information (such as information indicating protected attributes, majority, minority, and fairness metric values) that helps in selecting or creating governing principles. An individual enterprise (e.g., corresponding to one of the process simulators 200) can learn from other enterprises guardrails that optimize its processes. Thus, in some embodiments, the results of long-term simulation can be used to improve the ML models (in terms of fairness or performance, for example).

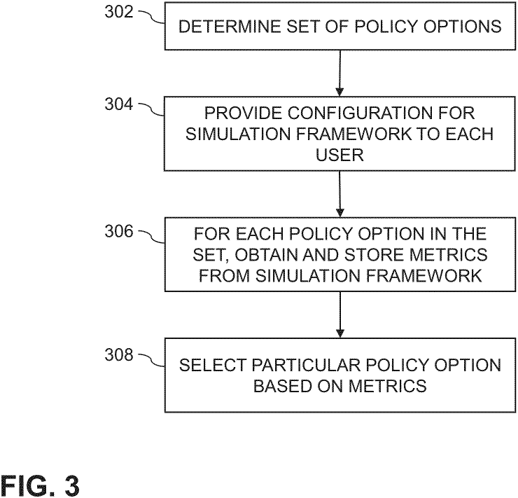

FIG. 3 is process flow diagram for simulating impact of policies on fairness of machine learning models in accordance with exemplary embodiments. Step 302 includes determining a set of policy options. For example, a governing body may provide a set of policy options to be used for simulating the long-term impact of those policies on a set of fairness and/or performance KPIs. Step 304 includes providing a configuration for a simulation framework to each relevant user (or enterprise) for building the respective process simulators (e.g., process simulators 200). The framework ensures privacy of enterprise data while providing policy and environment data for simulation. Step 306 includes, for each policy option, obtaining and storing metrics from the simulation framework. For example, each enterprise can provide access so that the simulator can be triggered remotely (e.g., on-demand) to participate in a simulation. Each of the simulators is “plugged in” to a central simulation system using details provided by the users/enterprises. Step 308 includes selecting a particular policy option based on the metrics resulting from the simulation.

Guardrails can include information related to timeframes, one or more thresholds, protected attributes, and an indication of the outcome, for example. As a non-limiting example, consider a long-term simulation on a credit dataset and a ML prediction model. In this example, the guardrails may include: “1-3 months, fairness threshold of disparity will be 0.8, protected attribute will be Age, protected attribute threshold: Age = 25, Favorable outcome = Yes, performance metric will be 95%” and “4-6 months, fairness threshold of disparity will be 0.75, protected attribute will be Age, protected attribute threshold: Age = 25, Favorable outcome = No, performance metric will be 93%.”

In at least some embodiments, a process may be performed to validate whether the information for a given ML model or process provided by an enterprise or user accurately reflects real world data. For example, the process may periodically check (e.g., every month) whether one or more performance KPIs and/or one or more fairness KPIs calculated from the simulation are within a certain threshold from observed (real world) values. If not, then the process may fine-tune one or more hyper-parameters of the simulation system.

For example, assume the following population data features are provided as input in a credit lending example: personⱼ = {age, gender, credit_score}, and a population simulator is configured as follows: prob_default_{j,t} = fl(ageⱼ, genderⱼ, credit_score_{j,t}), and credit_scoreⱼ₍ₜ₊₁₎ = f2(credit_score_{j,t}, defaulted_{j,t} ), where, prob_default_{j,t} is the probably of person j to default on a loan at time t, credit_score_{j,t} is the credit score of a person j at time t; and defaulted_{j,t} is a Boolean value to indicate whether person j has defaulted on a loan at time t.

Also assume the following policy is provided:

$$\frac{{\text{num\_approvals\_old}}_{\text{i}}}{{\text{num\_applications\_old}}_{\text{i}}} > \text{guardrail}$$

where, num_approvals_oldᵢ is the number of loan applications approved by the enterprise i for people over a specified age; and num_applications_oldᵢ is the total number of loan applications submitted to the enterprise i by people over the specified age. Generally, the results of the simulation can output the optimal value of the guardrail. In this example, the business workflow of an enterprise may be provided as: Get data → send to ML_modelᵢ → process paperwork for approved loans, and ML_modelᵢ(personⱼ) → {0, 1}, where ML_modelᵢ is a private ML model of enterprise i to approve or reject loans applications.

An intermediate output of the system may include a fairness KPI at a population level, for example:

$${\left(\frac{\text{num\_approvals\_old}}{\text{num\_applicaions\_old}} - \frac{\text{num\_approvals\_young}}{\text{num\_applications\_young}}\right)}^{2}$$

wherein a lower value of the KPI indicates less discrimination between older and younger applicants while approving the loans.

Another intermediate input may include a KPI at an enterprise level, such as:

$$\frac{{\text{num\_defaults}}_{i}}{{\text{num\_approvals}}_{i}}$$

where, num_defaultsᵢ is the number of defaulters for enterprise i, and num_approvalsⱼ is the total number of loan applications approved by the enterprise i.

The following table shows results of a simulation for the example above:

TABLE 1

| Iteration No. | Policy / guardrail | Enterprise1 KPI | Enterprise2 KPI | Fairness KPI for Population | Combined KPI for population |
|---|---|---|---|---|---|
| 1 | 0.1 | 13% | 7% | 0.37 | 0.57 |
| 2 | 0.2 | 16% | 10% | 0.32 | 0.55 |
| 3 | 0.3 | 22% | 11% | 0.23 | 0.605 |
| 4 | 0.4 | 23% | 10% | 0.17 | 0.665 |
| 5 | 0.5 | 27% | 9% | 0.03 | 0.385 |

In Table 1, the second column represent inputs for each iteration of the simulation, and the combined KPI in the last column is computed as f3 (Fairness KPI, KPI₁, KPI₂, ...). Thus, for this simulation the optimal KPI corresponds to iteration 5.

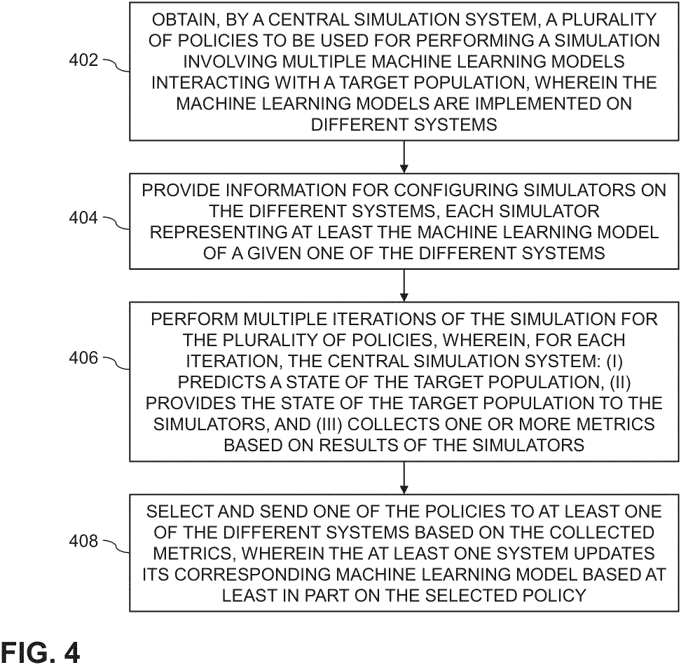

FIG. 4 is a flow diagram illustrating techniques for adjusting machine learning models in accordance with exemplary embodiments. Step 402 includes obtaining, by a central simulation system, a plurality of policies to be used for performing a simulation involving multiple machine learning models interacting with a target population, wherein the machine learning models are implemented on different systems. Step 404 includes providing information for configuring simulators on the different systems, each simulator representing at least the machine learning model of a given one of the different systems. Step 406 includes performing multiple iterations of the simulation for the plurality of policies, wherein, for each iteration, the central simulation system: (i) predicts a state of the target population, (ii) provides the state of the target population to the simulators, and (iii) collects one or more metrics based on results of the simulators. Step 408 includes selecting and sending one of the policies to at least one of the different systems based on the collected metrics, wherein the at least one system updates its corresponding machine learning model based at least in part on the selected policy.

The multiple machine learning models may each perform a common machine learning task. Each of the plurality of policies may include one or more constraints on the common machine learning task. At least one of the machine learning models may be trained based at least in part on a dataset that is specific to a given one of the different systems. In some embodiments, source code corresponding to the at least one machine learning model is not shared during the simulation. Also, in at least some embodiments, the dataset that is specific to the given one of the different systems is not shared during the simulation. The collected metrics may include one or more performance metrics associated with the machine learning models. The process may include a step of maintaining, by the central simulation system, one or more fairness metrics for the simulation. The process may include a step of aggregating the one or more fairness metrics and the one or more performance metrics to select the policy. The process may include the following steps of obtaining real world data corresponding to a particular time of the simulation; and validating at least one of: the one or more collected metrics and the one or more fairness metrics based at least in part on the real world data. The process may include the following steps: providing information to configure at least one other simulator of a new machine learning model; and adding the other simulator to the simulation after at least one of the iterations, wherein the adding comprises adjusting one or more parameters of one or more of the policies based on historical data associated with the new machine learning model. The simulation may simulate a time period of at least one year. The simulators may execute in different private cloud environments.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the present disclosure, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an embodiment of the present disclosure, the computer program product can include computer useable program code that is stored in a computer readable storage medium in a server data processing system, and wherein the computer useable program code is downloaded over a network to a remote data processing system for use in a computer readable storage medium with the remote system.

An exemplary embodiment or elements thereof can be implemented in the form of an apparatus including a memory and at least one processor that is coupled to the memory and configured to perform exemplary method steps.

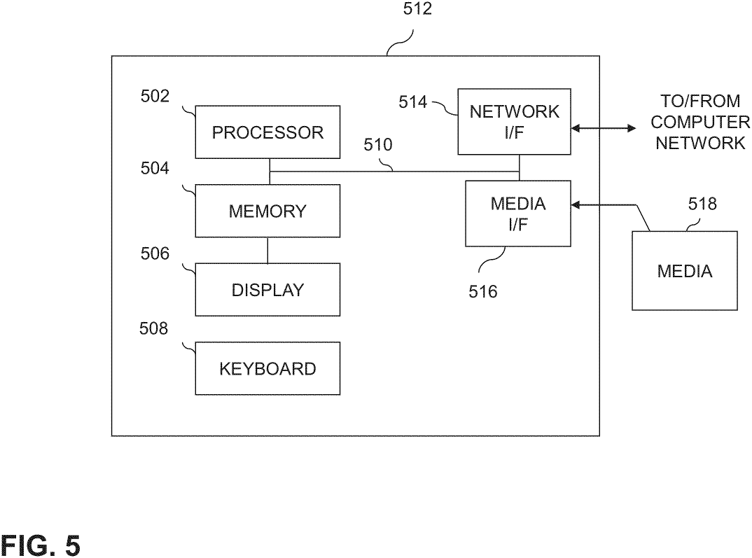

Additionally, an embodiment of the present disclosure can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the present disclosure, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

An exemplary embodiment may include a system, a method, and/or a computer program product at any possible technical detail level of integration. The computer program product may include a computer readable storage medium (or media) having computer readable program instructions thereon for causing a processor to carry out exemplary embodiments of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform embodiments of the present disclosure.

Embodiments of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings provided herein, one of ordinary skill in the related art will be able to contemplate other implementations of the components.

Additionally, it is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

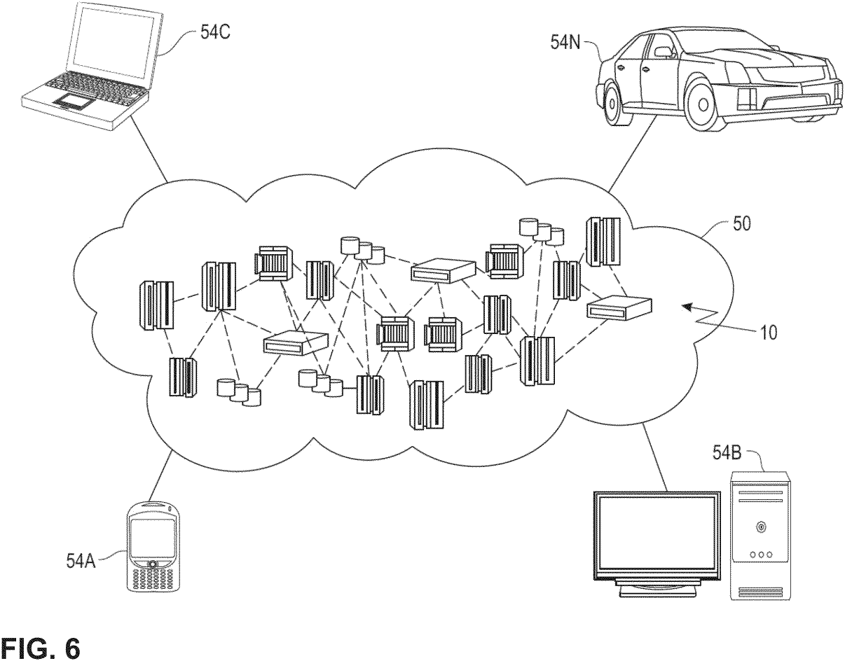

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

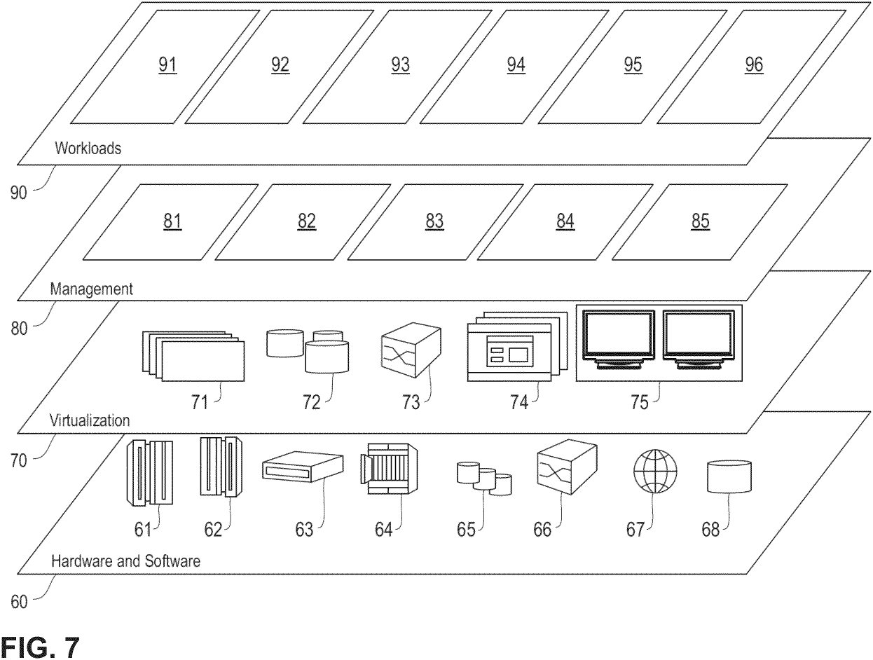

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and multi-model simulator 96, in accordance with the one or more embodiments of the present disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present disclosure may provide a beneficial effect such as, for example, measuring long-term impacts of policies on multiple ML models (e.g., performance and/or fairness impacts) using a simulation framework without the need to share private details and data corresponding to the ML models. Additionally, some embodiments provide a beneficial effect of updating one or more ML models based on results of the long-term simulation.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
obtaining, by a central simulation system, a plurality of policies to be used for performing a simulation involving multiple machine learning models interacting with a target population, wherein the machine learning models are implemented on different systems;
providing information for configuring simulators on the different systems, each simulator representing at least the machine learning model of a given one of the different systems;
performing multiple iterations of the simulation for the plurality of policies, wherein, for each iteration, the central simulation system: (i) predicts a state of the target population, (ii) provides the state of the target population to the simulators, and (iii) collects one or more metrics based on results of the simulators; and
selecting and sending one of the policies to at least one of the different systems based on the collected metrics, wherein the at least one system updates its corresponding machine learning model based at least in part on the selected policy;
wherein the method is carried out by at least one computing device.

2. The computer-implemented method of claim 1, wherein the multiple machine learning models each perform a common machine learning task.

3. The computer-implemented method of claim 2, wherein each of the plurality of policies comprises one or more constraints on the common machine learning task.

4. The computer-implemented method of claim 1, wherein at least one of the machine learning models is trained based at least in part on a dataset that is specific to a given one of the different systems.

5. The computer-implemented method of claim 4, wherein at least one of: (i) source code corresponding to the at least one machine learning model is not shared during the simulation and (ii) the dataset that is specific to the given one of the different systems is not shared during the simulation.

6. The computer-implemented method of claim 1, wherein the collected metrics comprise one or more performance metrics associated with the machine learning models.

7. The computer-implemented method of claim 6, comprising:
maintaining, by the central simulation system, one or more fairness metrics for the simulation.

8. The computer-implemented method of claim 7, comprising:
aggregating the one or more fairness metrics and the one or more performance metrics to select the policy.

9. The computer-implemented method of claim 7, comprising:
obtaining real world data corresponding to a particular time of the simulation; and
validating at least one of: the one or more collected metrics and the one or more fairness metrics based at least in part on the real world data.

10. The computer-implemented method of claim 1, comprising:
providing information to configure at least one other simulator of a new machine learning model; and
adding the other simulator to the simulation after at least one of the iterations, wherein the adding comprises adjusting one or more parameters of one or more of the policies based on historical data associated with the new machine learning model.

11. The computer-implemented method of claim 1, wherein the simulation simulates a time period of at least one year.

12. The computer-implemented method of claim 1, wherein the simulators execute in different private cloud environments.

13. The computer-implemented method of claim 1, wherein software is provided as a service in a cloud environment for implementing the central simulation system.

14. A computer program product comprising a computer readable storage medium having program instructions embodied therewith, the program instructions executable by a computing device to cause the computing device to:
obtain, by a central simulation system, a plurality of policies to be used for performing a simulation involving multiple machine learning models interacting with a target population, wherein the machine learning models are implemented on different systems;
provide information for configuring simulators on the different systems, each simulator representing at least the machine learning model of a given one of the different systems;
perform multiple iterations of the simulation for the plurality of policies, wherein, for each iteration, the central simulation system: (i) predicts a state of the target population, (ii) provides the state of the target population to the simulators, and (iii) collects one or more metrics based on results of the simulators; and
select and send one of the policies to at least one of the different systems based on the collected metrics, wherein the at least one system updates its corresponding machine learning model based at least in part on the selected policy.

15. The computer program product of claim 14, wherein the multiple machine learning models each perform a common machine learning task.

16. The computer program product of claim 15, wherein each of the plurality of policies comprises one or more constraints on the common machine learning task.

17. The computer program product of claim 14, wherein at least one of the machine learning models is trained based at least in part on a dataset that is specific to a given one of the different systems.

18. The computer program product of claim 17, wherein at least one of: (i) source code corresponding to the at least one machine learning model is not shared during the simulation and (ii) the dataset that is specific to the given one of the different systems is not shared during the simulation.

19. The computer program product of claim 14, wherein the collected metrics comprise one or more performance metrics associated with the machine learning models.

20. A system comprising:
a memory configured to store program instructions;
a processor operatively coupled to the memory to execute the program instructions to:
obtain, by a central simulation system, a plurality of policies to be used for performing a simulation involving multiple machine learning models interacting with a target population, wherein the machine learning models are implemented on different systems;
provide information for configuring simulators on the different systems, each simulator representing at least the machine learning model of a given one of the different systems;
perform multiple iterations of the simulation for the plurality of policies, wherein, for each iteration, the central simulation system: (i) predicts a state of the target population, (ii) provides the state of the target population to the simulators, and (iii) collects one or more metrics based on results of the simulators; and
select and send one of the policies to at least one of the different systems based on the collected metrics, wherein the at least one system updates its corresponding machine learning model based at least in part on the selected policy.
